(19) United States
(12) Patent Application Publication
(10) Pub. No.: US 2023/0093206 A1
(43) Pub. Date: Mar. 23, 2023

(54) DEVICES AND SYSTEMS FOR VIRTUAL PHYSICAL COMPETITIONS

(71) Applicant: AT&T Intellectual Property I, L.P., Atlanta, GA (US)

(72) Inventors: Barrett Kreiner, Woodstock, GA (US); James Pratt, Round Rock, TX (US); Adrianne Binh Luu, Atlanta, GA (US); Robert T. Moton, JR., Alpharetta, GA (US); Walter Cooper Chastain, Atlanta, GA (US); Ari Craine, Marietta, GA (US); Robert Koch, Peachtree Corners, GA (US)

(21) Appl. No.: 17/483,767

(22) Filed: Sep. 23, 2021

(51) Int. Cl. A63B 24/00; G06F 3/14; G06K 9/00; A63B 22/02; A63B 71/06

(52) U.S. Cl. CPC A63B 24/0084; G06F 3/14; G06K 9/00724; A63B 22/02; A63B 71/0622; A63B 24/0087; A63B 24/0062; A63B 2071/0638; A63B 2220/05; A63B 2220/806; A63B 2024/009; A63B 2024/0068

(57) ABSTRACT

A processing system including at least one processor may obtain at least one video of a first competitor along a competition route in a physical environment, obtain data characterizing at least one condition along the competition route as experienced by the first competitor, present visual data associated with the at least one video to a second competitor via a display device, and control at least one setting of at least one device associated with the second competitor to simulate the at least one condition, wherein the at least one device is distinct from the display device.

The present disclosure relates generally to augmented reality devices and systems, and more particularly to methods, computer-readable media, and apparatuses for presenting a simulated environment of a competition route for a second competitor.

### BACKGROUND

Augmented reality (AR) and/or mixed realty (MR) applications and video chat usage is increasing. In one example, an AR endpoint device may comprise smart glasses with AR enhancement capabilities. For example, the glasses may have a screen and a reflector to project outlining, highlighting, or other visual markers to the eye(s) of a user to be perceived in conjunction with the surroundings. The glasses may also comprise an outward facing camera to capture video of the physical environment from a field of view in a direction that the user is looking, which may be used in connection with detecting various objects or other items that may be of interest in the physical environment, determining when and where to place AR content within the field of view, and so on.

### SUMMARY

In one example, the present disclosure describes a method, computer-readable medium, and apparatus for presenting a simulated environment of a competition route for a second competitor. For instance, in one example, a processing system including at least one processor may obtain at least one video of a first competitor along a competition route in a physical environment, obtain data characterizing at least one condition along the competition route as experienced by the first competitor, present visual data associated with the at least one video to a second competitor via a display device, and control at least one setting of at least one device associated with the second competitor to simulate the at least one condition, wherein the at least one device is distinct from the display device.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates examples of screens that may be presented on a display during a competitive event as experienced by a competitor using a virtual competition system, in accordance with the present disclosure;

FIG. 3 illustrates a flowchart of an example method for presenting a simulated environment of a competition route for a second competitor; and

FIG. 4 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for presenting a simulated environment of a competition route for a second competitor. In particular, examples of the present disclosure enable two or more competitors, such as athletic competitors, to perform an event at the same or different times. For instance, in one example, the conditions of one competitor may be captured and simulated for another competitor. Thus, a competitor in an athletic event may compete on equal footing with another competitor, even if the two competitors perform the event at different times and in different locations. Although examples are described and illustrated herein primarily in connection with running competitors, examples of the present disclosure are equally applicable to biking, rowing, speed walking, and other events.

In an illustrative example, competitor 1 may perform a competitive athletic event in a real world environment, for example, if the event is a running event, it may be performed in a stadium, on a track, along a marathon or cross-country course, or other areas. Competitor 1 may be equipped with a smart device such as a smartwatch, and/or a biometric tracking device that tracks measures such as breathing rate, heart rate, pulse ox reading, along with motions such as steps taken. They may also be equipped with other wearables such as smart shoes that include sensors to track data such as stride distance, foot pressure, and other conditions.

Data representing competitor 1 may exist in a competitor database. The record may contain competitor identification data, such as a name, unique identifier (ID), team, age, and so forth. The record may also include past performance data, such as: event A best time, event A last time, event B best time, event B last time, etc. The record may further include biometric data, such as resting lung capacity, running stride, shoe size, height, weight, etc., equipment data, such as shoe type, and so on.

Competitor 1 may perform event A at a real-world venue. As competitor 1 performs the event, various sensors may record data associated with his or her performance of the event. The sensors may be present in on-board devices such as the biometric tracker, the smartwatch, and smart shoes, and a head-mounted video camera. Alternatively, these sensors may be external to the competitor, such as on an unmanned aerial vehicle (UAV) that follows competitor 1 during the performance of the event. The record of competitor 1's performance may be stored in an event database.

The record in the event database may contain environmental data such as: air temperature, humidity, aerial video (via UAV), competitor's view video (e.g., via head-mount cam), wind speed and direction, or the like. The record may also include current performance data, such as: location (which, in one example, may include an altitude), speed, gait stability data, a number of strides, and so forth. The record may further include biometric data, such as: breathing rate, heart rate, plantar pressure, stride distance, hydration level (such as via a smart bottle and/or moisture sensor(s) in clothing), and so on. The data measured may be collected by the competitor's smart device, for example, and communicated to the event database. Data readings may be made at synchronized intervals and timestamped when stored. The result is a timestamped timeline of data representing the conditions of the competitor's environment and of the competitor's body from the beginning to the end of the event.

The UAV and head-mounted video cameras may also be equipped with microphones and may capture both video and audio of the event from the runner's perspective and an aerial perspective. The audio and video may also be stored in the event database and it may be further analyzed to estimate and save other conditions of the event. For example, the running surface may be predicted based on a color analysis of the video. Shadow analysis may also predict the angle of the sun relative to the runner. Video analysis may also identify obstacles that the competitor may encounter that may affect the competitor's ability to perform. For example, if a dog runs in front of the competitor or if the competitor must alter his or her path to avoid a pothole or other obstacles, the identity and location of the obstacle at each point in time may be recorded. The video analysis may also be used to identify other nearby competitors who may be hindering the competitor's ability to run at a desired pace.

In one example, a simulated environment may be created for a competitor 2 to compete against the performance of competitor 1. Competitor 2 may be equipped with equipment that may be used to simulate an athletic event, such as a treadmill to simulate running or speed walking. Similarly, equipment may be used to simulate biking, rowing, or other events. The equipment may be responsive to data that requests adjustments to simulate changing conditions, such as incline, resistance, speed, and firmness of the running surface. The equipment may further be equipped with a video display and speakers to present a simulated audio and visual experience. A more immersive environmental simulated experience may exist if the equipment is in an enclosed environment, such as a room. In this case, the environment may be simulated further via changes to environmental control systems such as climate and lighting control systems to better simulate conditions of an outdoor competitive event.

Competitor 2 may choose to run a competition simulation against competitor 1 (e.g., a stranger, a known friend, a well-known athlete, etc.), simulating a run along the same route, encountering the same conditions that competitor 1 did when performing the event in real life. The timestamped data from competitor 1's performance of the event may be sent from the competition server to the various controls of the simulation to be invoked at the same time that competitor 1 experienced them. The system may compensate for the fact that competitor 2 may reach a point along the route at a different relative time than competitor 1. For instance, if competitor 2 starts going up a hill two minutes later than competitor 1 did, a time adjustment is made.

The timestamped instructions for competitor 1's performance may be sent to the various control systems. For example, the treadmill may adjust its level of incline based on a change in altitude from competitor 1's data. The video playback speed from competitor 1's head-mounted camera may be adjusted based on when competitor 2 reaches a certain distance relative to when competitor 1 did so. The room temperature, humidity level, and running surface tension may all be adjusted continually to simulate the conditions that existed for competitor 1. In one example, obstacles may be inserted visually through augmented reality (AR) displays or onscreen overlays.

In one example, a simulated image of competitor 1 at the same point in time during the event may be displayed on screen or via AR, including a display of competitor 1's relative position and pace. The same solution may be used if competitor 2 was to simulate the event against more than one other competitor. In a similar manner, a competitor may wish to race against previous other versions of the competitor. In this manner, the competitor may select to compete against a specified instance of the competitor's own past events, as stored in the event database.

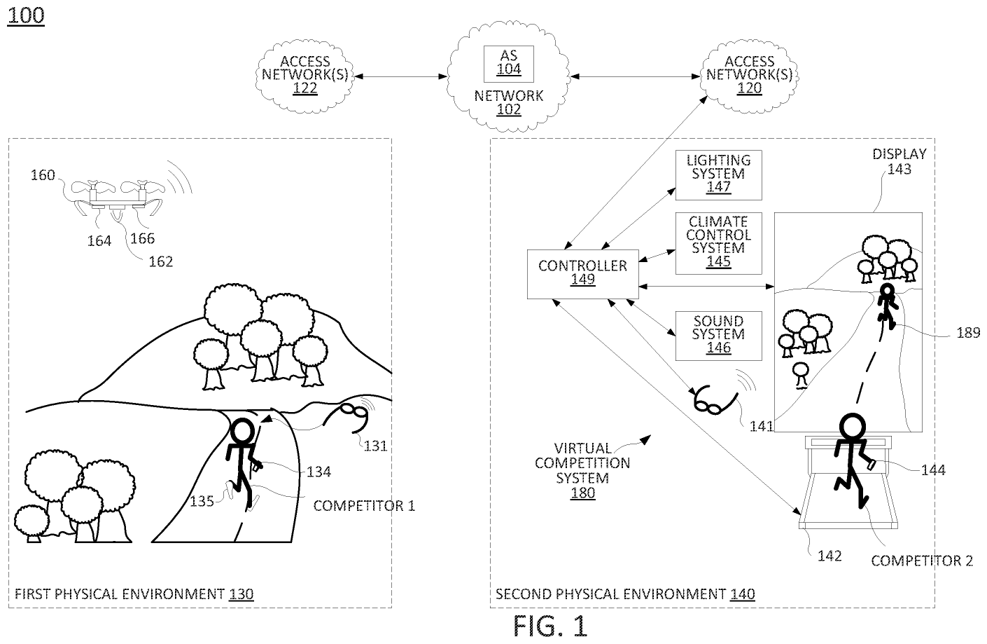

In one example, the event conditions for one competitor may be normalized for another competitor, to enable compensations to allow the two competitors to compete on a “level playing field,” even if they have different skill levels. For example, it may be determined that if one competitor has inferior equipment (e.g., heavier shoes, different number of spikes or placement of spikes, etc.), or shorter legs or smaller feet, which make for a shorter natural walking stride, or a difference in age, then the representation of the advantaged competitor may be represented with a time discrepancy that is to be overcome. In a like manner, a competitor may wish to race against a future version of the competitor 20 years later, which may be represented as a slower image based on an extrapolated performance prediction based on aging factors and current trends of the competitor's past performances. These and other aspects of the present disclosure are discussed in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., in accordance with 3G, 4G/long term evolution (LTE), 5G, etc.), and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video on demand (VoD) server, and so forth.

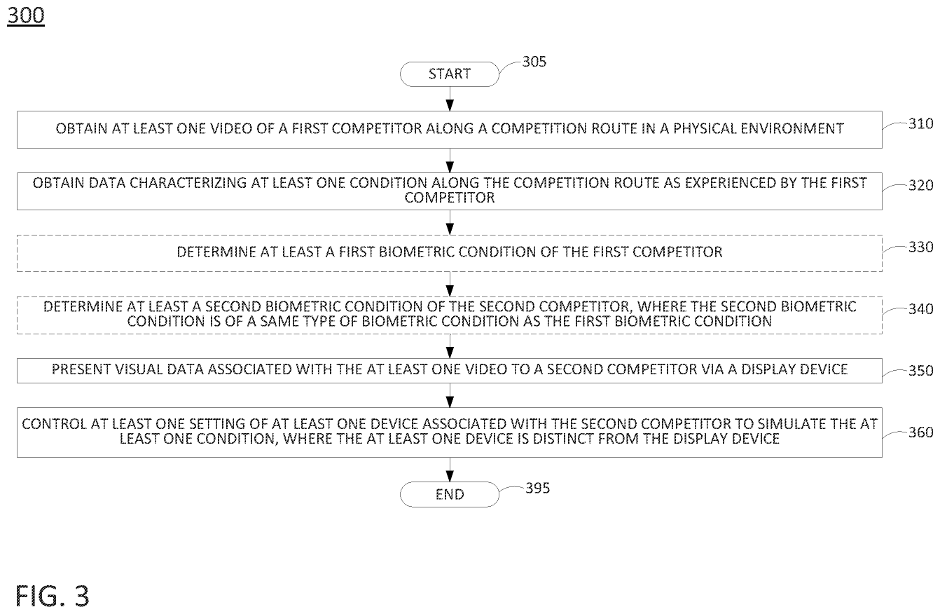

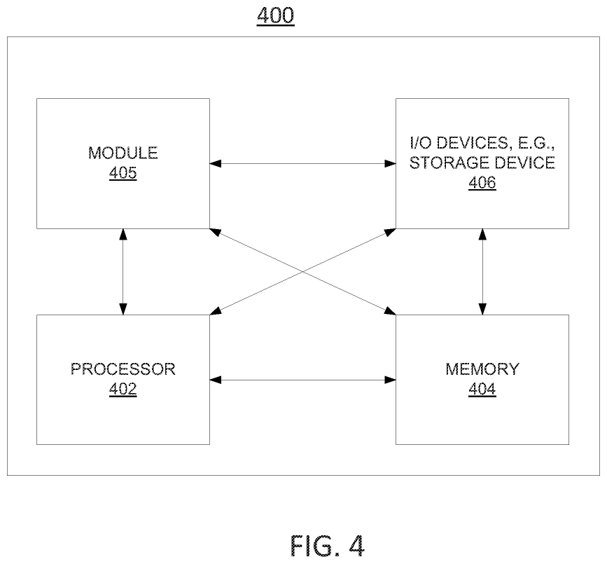

In accordance with the present disclosure, application server (AS) 104 may comprise a computing system or server, such as computing system 400 depicted in FIG. 4, and may be configured to provide one or more operations or functions for presenting a simulated environment of a competition route for a second competitor, such as illustrated and described in connection with the example method 300 of FIG. 3. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

Thus, although only a single application server (AS) 104 is illustrated, it should be noted that any number of servers may be deployed, and which may operate in a distributed and/or coordinated manner as a processing system to perform operations for presenting a simulated environment of a competition route for a second competitor, in accordance with the present disclosure. In one example, AS 104 may comprise an AR content server, or “competition server,” as described herein. In one example, AS 104 may comprise a physical storage device (e.g., a database server), to store various types of information in support of systems for presenting a simulated environment of a competition route for a second competitor, in accordance with the present disclosure. For example, AS 104 may store object detection and/or recognition models, user data (including user device data), event data associated with an event (e.g., as experienced by competitor 1 in first physical environment 130), biometric data of competitors 1 and and 2, and so forth that may be processed by AS 104 in connection with examples of the present disclosure for presenting a simulated environment of a competition route for a second competitor. For ease of illustration, various additional elements of network 102 are omitted from FIG. 1.

In one example, the access network(s) 122 may be in communication with one or more devices, such as device 131, device 134, device 135, and UAV 160, e.g., via one or more radio frequency (RF) transceivers 166. Similarly, access network(s) 120 may be in communication with one or more devices or systems including network-based and/or peer-to-peer communication capabilities, e.g., device 141, treadmill 142, display 143, lighting system 147, climate control system 145, sound system 146, and/or controller 149. In one example, various devices or systems in second physical environment 140 may communicate directly with one or more components of access network(s) 120. In another example, controller 149 may be in communication with one or more components of access network(s) 120 and with device 141, treadmill 142, display 143, device 144, lighting system 147, climate control system 145, and/or sound system 146, and may send instructions to, communicate with, or otherwise control these various devices or systems to provide a competitive environment for an event, e.g., for competitor 2. In one example, various devices at the second physical environment 140 may comprise a virtual competition system 180 wherein the various devices work in conjunction with one another to simulate a competitive event, such as taking place at first physical environment 130 and involving one or more competitors (e.g., at least competitor 1), by recreating the conditions as experienced by at least competitor 1 during such event.

In accordance with the present disclosure, UAV 160 may include a camera 162 and one or more radio frequency (RF) transceivers 166 for cellular communications and/or for non-cellular wireless communications. In one example, UAV 160 may also include one or more module(s) 164 with one or more additional controllable components, such as one or more: microphones, loudspeakers, infrared, ultraviolet, and/or visible spectrum light sources, projectors, light detection and ranging (LiDAR) units, temperature sensors (e.g., thermometers), and so forth. In one example, UAV 160 may record video of competitor 1 engaging in a competitive event at the first physical environment 130. For instance, UAV 160 may capture video comprising image(s) of competitor 1 along a route of the event and/or images of the surrounding environment, such as the terrain of a competition route (e.g., a roadway), terrain around the competition route, e.g., grass, trees, a hillside, and so forth. In addition, UAV may also record other aspects of the first physical environment, such as recording audio, taking temperature, humidity, precipitation or similar measurements. In one example, UAV 160 may be uncrewed, but controlled by a human operator, e.g., via remote control. In another example, UAV 160 may comprise an autonomous aerial vehicle (AAV) that may be programmed to perform independent operations, such as to track and film competitor 1, for example.

As illustrated in FIG. 1, devices 134 and 144 may each comprise a biometric measurement device, for example, a wireless enabled wristwatch equipped with a sensor to detect electrocardiogram (ECG/EKG) data, pulse data, blood oxygen level data, cholesterol data, sleep/wake data, blood pressure data, movement data (e.g., number of steps, number of pedals, etc.), or the like. Although only a single device for each competitor is illustrated for collecting biometric data, it should be understood that in another example, different types of biometric data may be collected from multiple wearable biometric devices of either or both of competitor 1 and competitor 2. For instance, in the example of FIG. 1, competitor 1 is further equipped with smart shoes, e.g., device 135, which may include sensors embedded in the soles to measure a number of strides, stride length, duration of ground contact, contact pressure, and so on.

In one example, each of the devices 131 and 141 may comprise any single device or combination of devices that may comprise a user endpoint device. For example, the devices 131 and 141 may each comprise a mobile device, a cellular smart phone, a wearable computing device (e.g., smart glasses) a laptop, a tablet computer, or the like. In one example, each of the devices 131 and 141 may include one or more radio frequency (RF) transceivers for cellular communications and/or for non-cellular wireless communications. In addition, in one example, devices 131 and 141 may each comprise programs, logic or instructions to perform operations in connection with examples of the present disclosure for presenting a simulated environment of a competition route for a second competitor. For example, devices 131 and 141 may each comprise a computing system or device, such as computing system 400 depicted in FIG. 4.

Access networks 120 and 122 may transmit and receive communications between such devices/systems, and application server (AS) 104, other components of network 102, devices reachable via the Internet in general, and so forth. In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and others may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like. For instance, in one example, one of the access network(s) 122 may be operated by or on behalf of a first venue (e.g., associated with first physical environment 130). Similarly, in one example, one of the access network(s) 120 may be operated by or on behalf of a second venue (e.g., associated with second physical environment 140). In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with devices in the first physical environment 130 and second physical environment 140.

In an illustrative example, the device 131 is associated with a first competitor (competitor 1) at a first physical environment 130. As illustrated in FIG. 1, the device 131 may comprise a wearable computing device (e.g., smart glasses) and may provide a user interface for competitor 1. For instance, device 131 may comprise smart glasses or goggles with augmented reality (AR) enhancement capabilities. For example, endpoint device 131 may have a screen and a reflector to project outlining, highlighting, or other visual markers to the eye(s) of competitor 1 to be perceived in conjunction with the surroundings. In one example, device 131 may also comprise an outward facing camera to capture video of the first physical environment 130 from a field of view in a direction that competitor 1 is looking. Similarly, device 131 may further include a microphone for capturing audio of the first physical environment 130 from the location of competitor 1. Device 131 may also measure, record, and/or transmit data related to movement and position, such as locations, orientations, accelerations, and so forth. For instance, device 131 may include a Global Positioning System (GPS) unit, a gyroscope, a compass, one or more accelerometers, and so forth.

In one example, device 131 may be in wireless communication (or “paired”) with device 134 and 135. For instance, devices 134 and 135 may collect measurements as noted above (such as heart rate, breathing rate/pulse, contact pressure, stride length, contact duration, etc.) and forward the measurements to device 131. In turn, device 131 may upload recorded video, audio, measurements from devices 134 and 135, and so forth to AS 104, e.g., via access network(s) 122, network 102, etc. For example, competitor 1 may be engaging in a competitive event at first physical environment 130 in connection with which AS 104 may collect event data. Similarly, UAV 160 may record video, audio, or capture other measurements of first physical environment via camera 162 and/or module 164, and may forward any or all of such collected data to AS 104. For instance, UAV 160 may be programmed or otherwise controlled to track competitor 1, e.g., by detecting and/or communicating with device 131, device 134, or the like, and to record video or other aspects of the first physical environment 130 as experienced by competitor 1 (or as close to competitor 1 as UAV 160 tracks/follows).

As noted above, event data may be stored in an event record to include: environmental data, such as aerial video (via UAV 160), competitor-view video (e.g., via head-mount cam of device 131), air temperature, humidity, wind speed and direction, or the like (e.g., from UAV 160 and/or any of devices 131, 134, or 135); current performance data, such as location (which, in one example, may include an altitude), speed, gait stability data, a number of strides, and so forth; biometric data, such as breathing rate, heart rate, plantar pressure, stride distance, hydration level (such as via a smart bottle and/or moisture sensor(s) in clothing), and so on. Data readings may be made at synchronized intervals and timestamped when stored. The result is a timestamped timeline of data representing the conditions of the first physical environment 130 as experienced by competitor 1, and of competitor 1's body from the beginning to the end of the event or at various points or milestones of the event.

In the example of FIG. 1, competitor 2 may engage to compete virtually in the event (e.g., against at least competitor 1) using virtual competition system 180 in the second physical environment 140 and in coordination with AS 104. It should be noted that in one example, visual and audio aspects of experiencing the competitive event may be provided for competitor 2 via device 141, e.g., by presenting video as AR content with accompanying audio. However, for illustrative purposes, the present example is illustrated in FIG. 1 and primarily described in connection with the use of display 143 and sound system 146. In the present example, competitor 2 may begin to engage in the event. AS 104 and/or controller 149 may keep track of a virtual location/position of competitor 2 along the competition route as competitor 2 begins to run on treadmill 142. For instance, treadmill 142 may report the distance of movement of a conveyor pad and/or speed of competitor 2 to controller 149 and/or AS 104. For example, at the start of the event for competitor 2, the timing and position of competitor 2 may be the same as competitor 1, but the positions (and/or distances) along the competition route may then begin to diverge as the elapsed time progresses and as competitor 2 may run faster or slower than competitor 1. In one example, AS 104 may provide video and audio data of the competition route to controller 149 which may cause a video to be presented via display 143 and audio to be presented via sound system 146. Within the video, a simulated image 189 of competitor 1 at the same point in time during the event may be included such that competitor 2 can visualize competitor 1's relative positions and paces throughout the event (e.g., when competitor 1 is within a field of view of competitor 2).

In one example, AS 104 may also provide other time-stamped event data, such as temperature data, event route surface data, and so forth to controller 149. In one example, AS 104 may provide all or a portion of the time-stamped (and location-stamped) event data to controller 149. In another example, AS 104 may continue to receive data from treadmill 142, indicative of the progress of competitor 2 along an event route, e.g., a distance travelled, and may select and forward event data to controller 149 for presentation via components of the virtual competition system 180 at designated elapsed times since competitor 2 started the event and/or the times when the competitor 2 is at the determined locations. For instance, AS 104 may forward event data for a predicted location at which competitor 2 will reach in the next two seconds, the next five seconds, or the like (e.g., along a virtual/simulated version of the competition route traversed by competitor 1 in the first physical environment 130). Alternatively, or in addition, AS 104 may forward event data associated with an elapsed time, to be presented for competitor 2. In one example, event data associated with competitor 2 can be provided to competitor 1, e.g., as an audio signal via an earbud (e.g., “Competitor 2 is behind you,” “Competitor 2 is ahead of you,” “Competitor 2 is approximately 100 feet behind you,” “Competitor 2 is approximately 100 feet ahead of you,” and so on). This will allow competitor 1 to ascertain the progress of one or more virtual competitors who are not physically located at the first physical environment 130.

In one example, conditions associated with competitor 1 and/or the first physical environment 130 during the performance of the event by competitor 1 may be directly obtained from components in the first physical environment 130, e.g., temperature, humidity, brightness, position and/or distance, etc. Thus, for example, AS 104 and/or controller 149 may cause climate control system 145 to set and/or adjust a temperature in the second physical environment to be a same temperature as recorded for a particular time or location during the performance of the event by competitor 1 in the first physical environment 130, a same humidity, and so on. For instance, the second physical environment may be an enclosed space and the climate control system 145 may comprise a thermostat and/or a humidistat with controls to dehumidifier and/or humidifier. In accordance with the present disclosure, climate control system 145 may alternatively or additionally comprise one or more fans (e.g., for generating and simulating wind), one or more sprinklers (e.g., for simulating rain), or the like. Similarly, AS 104 and/or controller 149 may cause lighting system 147 to set and/or adjust a brightness to be the same as recorded for a particular time or location during the performance of the event by competitor 1 in the first physical environment 130. In one example, lighting system 147 may also be adjustable and controllable such that one or more light sources are repositionable around treadmill 142. For instance, one or more light sources of lighting system 147 may be repositioned to simulate the same position and/or angle of the sun as experienced by competitor 1.

Alternatively, or in addition, other conditions may be determined by AS 104 from the collected event data (e.g., and then added back to the event data as new event data). For instance, AS 104 may determine a surface condition along the competition route from analysis of video from device 131 and/or video from UAV 160. For example, a machine learning model (MLM) may be trained to detect and distinguish between asphalt, concrete, gravel, dirt, mud, loose sand, hard sand, grass, pebbles, rubber track, and/or other surfaces that may appear in a video (and/or in at least one image or frame from a video) and/or conditions of such surfaces, e.g., wet, snow, etc. It should be noted that in other examples, a MLM may be trained to distinguish between conditions on a water surface, such as small chop, heavy chop, swells less than two feet, swells more than 2 feet, etc.

Similarly, AS 104 may detect conditions resulting in delay or obstruction. For instance, AS 104 may detect a substantial change in pace of competitor 1 from position/distance data and may further detect events/items of visual significance in video and/or images from device 131 and/or UAV 160 (e.g., via one or more additional trained machine learning models). Upon either or both of these occurrences, AS 104 may record a delay/obstruction event in the event record (associated with the time of the occurrence and/or the position (or distance) at which the occurrence is experienced by competitor 1).

To illustrate, AS 104 may generate (e.g., train) and store detection models that may be applied by AS 104, in order to detect items of interest in video from device 131, UAV 160, etc. For instance, in accordance with the present disclosure, the detection models may be specifically designed for surface types, types of items or object that may be obstructions such as other competitors (e.g., humans), bicycles, cars or other vehicles, dogs or other animals, and so forth. The MLMs, or signatures, may be specific to particular types of visual/image and/or spatial sensor data, or may take multiple types of sensor data as inputs. For instance, with respect to images or video, the input sensor data may include low-level invariant image data, such as colors (e.g., RGB (red-green-blue) or CYM (cyan-yellow-magenta) raw data (luminance values) from a CCD/photo-sensor array), shapes, color moments, color histograms, edge distribution histograms, etc. Visual features may also relate to movement in a video and may include changes within images and between images in a sequence (e.g., video frames or a sequence of still image shots), such as color histogram differences or a change in color distribution, edge change ratios, standard deviation of pixel intensities, contrast, average brightness, and the like. For instance, these features could be used to help quantify and distinguish a concrete floor from a patch of sand, etc. In one example, the detection models may be used to detect particular items, objects, or other physical aspects of an environment (e.g., rain, snow, fog, etc.).

In one example, MLMs, or signatures, may take multiple types of sensor data as inputs. For instance, MLMs or signatures may also be provided for detecting particular items based upon LiDAR input data, infrared camera input data, and so on. In accordance with the present disclosure, a detection model may comprise a machine learning model (MLM) that is trained based upon the plurality of features available to the system (e.g., a “feature space”). For instance, one or more positive examples for a feature may be applied to a machine learning algorithm (MLA) to generate the signature (e.g., a MLM). In one example, the MLM may comprise the average features representing the positive examples for an item in a feature space. Alternatively, or in addition, one or more negative examples may also be applied to the MLA to train the MLM. The machine learning algorithm or the machine learning model trained via the MLA may comprise, for example, a deep learning neural network, or deep neural network (DNN), a generative adversarial network (GAN), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. In one example, a trained detection model may be configured to process those features which are determined to be the most distinguishing features of the associated item, e.g., those features which are quantitatively the most different from what is considered statistically normal or average from other items that may be detected via a same system, e.g., the top 20 features, the top 50 features, etc.

In one example, detection models (e.g., MLMs) may be trained and/or deployed by AS 104 to process videos from device 131 and/or UAV 160, and/or other input data to identify patterns in the features of the sensor data that match the detection model(s) for the respective item(s). In one example, a match may be determined using any of the visual features mentioned above, e.g., and further depending upon the weights, coefficients, etc. of the particular type of MLM. For instance, a match may be determined when there is a threshold measure of similarity among the features of the video or other data streams(s) and an item/object signature. Similarly, in one example, AS 104 may apply an object detection and/or edge detection algorithm to identify possible unique items in video or other visual information (e.g., without particular knowledge of the type of item; for instance, the object/edge detection may identify an object in the shape of a tree in a video frame, without understanding that the object/item is a tree). In this case, visual features may also include the object/item shape, dimensions, and so forth. In such an example, object recognition may then proceed as described above (e.g., with respect to the “salient” portions of the image(s) and/or video(s)).

Returning to the example of FIG. 1, the event data provided by AS 104 to controller 149 may thus include surface conditions for particular locations/distances detected via video from device 131 and or UAV 160. Alternatively, or in addition, surface conditions may be detected by AS 104 from data from device 135 and or device 131, e.g., ground contact data, stability data of competitor 1, or the like. For instance, this sensor data may be indicative of an unevenness of ground, a hardness of the ground, and so on. In one example, treadmill 142 may be equipped with a variable firmness setting for the conveyor surface, such as via an adjustable tension of the conveyor mat/pad, adjustable spring tension in shock absorbers for one or more rollers, and so on. Thus, the treadmill 142 may receive instructions as to a firmness level to apply at any given time (e.g., corresponding to a location and/or distance along a competition route at which competitor 2 is determined to be at or will be passing soon). Alternatively, or in addition, treadmill 142 may be instructed to adjust a resistance of the conveyor mat, for instance increasing the resistance (or even an incline) to simulate the added effort to run through sand, or the like. It should be noted that in some cases, the virtual competition system 180 may not be equipped to simulate all conditions that are detected for competitor 1 in the first physical environment 130. Accordingly, in one example, the controller 149 may apply a correction factor based upon one or more differences in conditions that cannot be simulated. For instance, if the treadmill 142 cannot simulate the experience of running on loose rocks, controller 149 may instead implement a delay factor based upon the difference in surfaces (e.g., loose rocks versus a default or other setting of treadmill 142) and a duration of time for which the difference in surfaces is applicable.

In one example, during competitor 1's performance of the event, at time X and location Y (or distance Z) an occurrence of an obstruction may be detected, e.g., via one or more MLMs trained by and/or deployed on AS 104 such as described above. For instance, a dog may run across the road just in front of competitor 1, causing competitor 1 to have to slow down or divert. The occurrence may be detected visually, such as noted above, and may alternatively or additionally be detected, or the detection may be confirmed by a correlated slowing of pace at the same elapsed time as the occurrence in the video(s). The substantiality of the change in pace may be a configurable parameter and set by a system operator, such as a decline in pace of at least 25 percent over a period of at least two seconds as compared to a moving average of competitor 1's pace (e.g., over the last 2 minutes, the last 5 minutes, or the like).

In one example, the present disclosure may be configured to re-create, or simulate, such a condition at the same elapsed time (e.g., time X) for competitor 2, regardless of the progress of competitor 2 along a distance of the event course. For instance, competitor 2 may be at location A at time X. Although the dog was experienced by competitor 1 at location Y, nevertheless AS 104 and/or controller 149 may cause the occurrence of the dog (e.g., an occurrence of an obstruction), to be imposed on competitor 2 at elapsed time X. This may include adding a visual representation of the dog to the video to be presented via display 143 (e.g., where the video associated with location A as captured by competitor 1 at a different elapsed time does not include the dog) and similarly audio of the dog via sound system 146. In one example, AS 104 and/or controller 149 may also instruct treadmill 142 to increase a resistance to the conveyor such that competitor 2 is slowed down in a similar manner as competitor 1 who physically encountered the dog. In another example, AS 104 and/or controller 149 may cause the occurrence of the dog to take place whenever competitor 2 reaches the same location Y (or distance Z) at which the dog was experienced by competitor 1, e.g., regardless of when competitor 2 reaches that same location/distance virtually via treadmill 142. Other obstructions that may be detected in connection with competitor 1 and re-created for competitor 2 may be moveable, such as cars, bicycles, pedestrians, other competitors, dogs, other animals, etc. or may be fixed or relatively fixed, such as a pothole, puddle, fallen tree, and so forth.

Thus, the virtual competition system 180 attempts to simulate the conditions of a competitive event as experienced by competitor 1 for competitor 2 in terms of visual and audio, as well as any one or more of surface conditions, temperature, humidity, light level, obstructions, and other factors. It should be noted that the foregoing illustrates just one example of a system in which examples of the present disclosure for presenting a simulated environment of a competition route for a second competitor may operate and that in other, further, and different examples, the present disclosure may use more or less components, may use components in a different way, and so forth. For instance, in one example, climate control system 145 in the second physical environment 140 may further include sprinklers to simulate rain that may be detected in the first physical environment 130. In another example, competitor 2 may participate in the event using device 141, e.g., instead of display 143 and/or sound system 146. For instance, device 141 may provide an augmented reality (AR) or a mixed reality (MR) environment, e.g., when the second physical environment 140 remains visible to competitor 2 when using device 141, and visual content from AS 104 is presented spatially in an intelligent manner with respect to the second physical environment 140. For example, competitor 2 may run on streets in competitor 2's own neighborhood (or a track in a stadium), distance may be tracked, for example via a GPS unit of device 141, while visual data from first physical environment 130, e.g., obtained from competitor 1's experience may be presented as overlay data so as to simulate being along the competition route at the first physical environment 130. For example, AR visual content from AS 104 may be presented as a dominant overlay such that the user can mostly pay attention to AR content from the first physical environment 130, but also such that that real-world imagery of second physical environment 140 is not completely obstructed. For instance, the AR content may appear as transparent (but dominant) imagery via angled projection on a glass or similar screen within a field of view of competitor 2.

It should be noted that as used herein, the terms augmented reality (AR) environment may be used herein to refer to the entire environment experienced by a user, including real-world images and sounds combined with generated images and sounds. The generated images and sounds added to the AR environment may be referred to as “virtual objects” and may be presented to users via devices and systems of the present disclosure. While the real world may include other machine generated images and sounds, e.g., animated billboards, music played over loudspeakers, and so forth, these images and sounds are considered part of the “real-world,” in addition to natural sounds and sights such as other physically present humans and the sound they make, the sound of wind through buildings, trees, etc., the sight and movement of clouds, haze, precipitation, sunlight and its reflections on surfaces, and so on. In still another example, the system 100 may relate to a paddle sport event wherein competitor 1 may for instance row along a waterway or course, event data may be captured, and then the event simulated for competitor 2 using a rowing machine instead of treadmill 142, and similarly for a cycling event using a stationary cycle, and so forth.

In addition, although the foregoing example(s) is/are described and illustrated in connection with a single competitor at first physical environment 130 and with a single competitor competing virtually at a second physical environment 140, it should be noted that various other scenarios may be supported in accordance with the present disclosure wherein multiple competitors participate live, in-person at first physical environment 130 (e.g., 200 individuals running in a marathon on the streets of a city) and/or wherein multiple competitors participate virtually at or around the same time (e.g., 1000 individuals running the marathon virtually at home), or at different times, on different days, at various different locations, and so forth. Thus, these and other modifications are all contemplated within the scope of the present disclosure.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to AS 104 may alternatively or additionally be performed by controller 149, and vice versa. In addition, although a single AS 104 is illustrated in the example of FIG. 1, in other, further, and different examples, the same or similar functions may be distributed among multiple other devices and/or systems within the network 102, access network(s) 120 or 122, and/or the system 100 in general that may collectively provide various services in connection with examples of the present disclosure for presenting a simulated environment of a competition route for a second competitor. Additionally, devices that are illustrated and/or described as using one form of communication (such as a cellular or non-cellular wireless communications, wired communications, etc.) may alternatively or additionally utilize one or more other forms of communication. Thus, these and other modifications are all contemplated within the scope of the present disclosure.

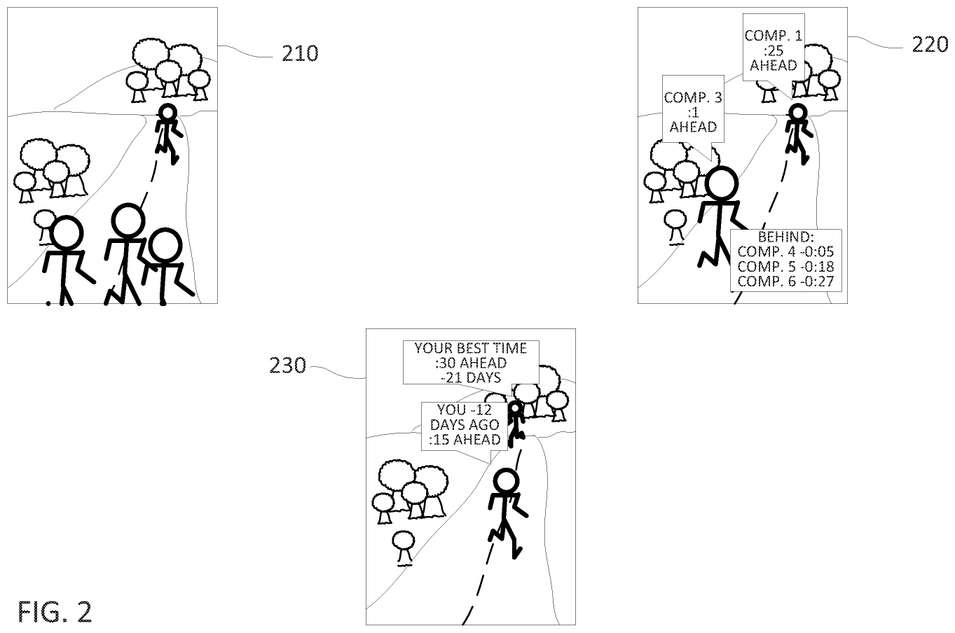

To further aid in understanding the present disclosure, FIG. 2 illustrates additional examples of screens that may be presented on a display during a competitive event as experienced by a competitor using a virtual competition system. For instance, the display may be the same or similar to the display 143 of FIG. 1. In a first additional example, the display may present a screen 210 illustrated in FIG. 2 in which an obstruction may be presented visually. For instance, as noted above in connection with the example of FIG. 1, competitor 1 may be hindered from running at full pace, or at least a preferred speed at some point during the event, due to other competitors on the course. As also noted above, this occurrence may be recorded in the event database as an obstruction that is present at a particular time and/or location/distance along the course. As such, the occurrence may be re-created for a second competitor (e.g., competitor 2 of FIG. 1) as illustrated in screen 210 of FIG. 2. For instance, in one example, even if competitor 2 is behind competitor 1 at the time illustrated in screen 210, the obstruction may be presented as competitor 2 reaches the same location, or distance along the course, as competitor 1 experienced the obstruction. It should be noted that this is just one example configuration and that in another example, the obstruction may be presented only to the extent that competitor 2 may be at the same distance along the course at the same elapsed time as competitor 1 experienced the occurrence of the obstruction. Otherwise, there may be no obstruction presented visually, or a simulated visual of the obstruction may be presented visually in the distance if competitor 2 is behind competitor 1 and competitor 1 is within range and field of view of a current position along the course of competitor 2. Other obstructions, such as dogs running onto the course, vehicles crossing, competitors crashing into each other and so on may be presented in the same or similar manner.

In another example, screen 220 illustrates that additional competitors may be presented visually. For instance, multiple competitors at an event that is live and in-person may be tracked in a similar manner and may be determined to be ahead of a competitor using the display presenting screen 220. As such, visual representations of multiple competitors may be added to the video to appear at positions along the course ahead. In one example, other competitors using respective virtual competition systems may be tracked throughout a performance of the event (concurrently with the competitor using the display presenting screen 220, or at earlier time(s)) and visual representations of such competitors may also be inserted into the video. In one example, additional information may be presented, e.g., in dialog boxes or the like, such as identifications of the other competitors, the times ahead, the distances ahead, and so forth. Similarly, information on competitors not within the field of view (e.g., behind the competitor using the display presenting screen 220) may also be presented in an overlay of the video on the screen 220.

A third example screen 230 illustrates another example in which a competitor may be presented with virtual representations of the same competitor at past instances of the same event, or the same type of event. For instance, in the example of FIG. 2, the competitor may see representations of the competitor's position from the same event 21 days prior to a current time, and from 12 days prior to a current time (which are both ahead of the competitor's current position at the same elapsed time as represented by the screen 230). This will allow a competitor to gauge his or her current performance from his or her own prior performances. It should be noted that the foregoing are just several additional examples of visual representations of virtual participation in a competitive event, in accordance with the present disclosure. For instance, in another example, future performance of a competitor may be extrapolated from current performance and/or recent performances (e.g., the competitor is improving in speed, endurance, oxygen utilization, muscle mass, etc.), aging factors, and so forth, such that the competitor may be projected to be faster or slower at some point in the future. Accordingly, a virtual representation of the competitor from one or more future predicted performances may similarly be presented (e.g., similar to the example screen 230). For example, the system may provide a visual representation of the competitor based on one or more predictions as to how the competitor should be performing currently, e.g., based on training parameters. Similarly, future performance of another competitor may be extrapolated from current performance and/or recent performances, aging factors, and so forth, such that the competitor may compete against a predicted version of the other competitor, or multiple predicted versions of the other competitor, such as at several future ages.

It should also be noted that in each of the examples of FIG. 2, a server, such as AS 104, or other components such as illustrated in FIG. 1, may obtain one or more videos from a live, in-person participation in an event (e.g., including at least competitor 1) from which the video may be processed and modified to include additional imagery of competitor 1, obstructions, and so forth. For instance, the video may be presented in a sped-up fashion (e.g., by dropping some frames, merging frames, etc.) or delayed fashion (e.g., by repeating some frames, or the like) depending upon whether a second competitor using a virtual competition system is behind or ahead of a first competitor participating live, in-person and in connection with whom the video of the event performance has been captured. In addition, in one example, imagery of obstructions may be extracted from some frames and inserted into other frames (e.g., so as to have an obstruction occur at a different location, but at a same elapsed time as experienced by the first competitor), and so on.

FIG. 3 illustrates a flowchart of an example method 300 for presenting a simulated environment of a competition route for a second competitor. In one example, steps, functions and/or operations of the method 300 may be performed by a device or apparatus as illustrated in FIG. 1, e.g., by AS 104, or any one or more components thereof, or by AS 104, and/or any one or more components thereof in conjunction with one or more other components of the system 100, such as controller 149 and/or other components of virtual competition system 180, UAV 160, device 131, and so forth. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and proceeds to step 310.

At step 310, the processing system obtains at least one video of a first competitor along a competition route in a physical environment. For example, as described above, the at least one video may be obtained from either or both of a camera of a wearable computing device of the first competitor or an uncrewed vehicle (e.g., a UAV). In one example, the at least one video may also come from a camera of another person traveling in front, alongside, behind, or overhead of the first competitor.

At step 320, the processing system obtains data characterizing at least one condition along the competition route as experienced by the first competitor. For instance, the at least one condition may comprise a perceptible environmental condition that can be detected at a first location and which can be generated/applied via one or more physical devices at a second location. For instance, the data characterizing the at least one condition may be obtained from at least one environmental sensor, such as a light sensor, a humidity sensor, a temperature sensor, a wind sensor (e.g., for recording wind speed and/or direction) an atmospheric pressure sensor, or the like. In one example, the data characterizing the at least one condition may be detected from the at least one video. For instance, the at least one condition may comprise an occurrence of at least one movable obstacle, such as a human (including a pedestrian or other competitors), an animal, a vehicle, etc. The at least one condition may alternatively or additionally comprise a precipitation condition, a light condition, a surface type, a wind condition, and/or a surface condition. For instance, in one example, the data characterizing the at least one condition may comprise data pertaining to a surface along the route, where the at least one condition may comprise a surface type or a surface condition (e.g., the surface type can be “pavement” and the surface condition can be “smooth” or “rough,” or the surface type can be “pavement” and the condition can be “wet” or “dry,” and so forth). In one example, the data pertaining to the surface along the route may be obtained from at least one sensor of an object in contact with the surface, such as shoes, vehicle wheels and/or suspension, or the like, a clinometer (also referred to as inclinometer) mounted on a vehicle or a boat (e.g., which would be indicative of land surface roughness/bumpiness, water choppiness, etc.).

At optional step 330, the processing system may determine at least a first biometric condition of the first competitor. For instance, the at least the first biometric condition may be detected from one or more biometric sensors of the first competitor, such as a heart rate monitor, a breathing rate monitor, a pressure sensor in the first competitor's shoes, etc. Alternatively, or in addition, the at least the first biometric condition may comprise a relatively static measure, such as the first competitor's height, femur length, arm reach, maximal oxygen uptake (e.g., VO2 max), age, and so forth.

At optional step 340, the processing system may determine at least a second biometric condition of the second competitor, where the second biometric condition is of a same type of biometric condition as the first biometric condition. For example, the type of biometric condition may a leg length, a femur length, a stride length, an arm reach, a height, an age, a VO2 max, and so forth of the second competitor. In one particular example, the identity of the second competitor may be the same as the first competitor. For instance, as described above, in one example, a competitor may compete against the competitor's own past performances of a same event (or same type of event, e.g., a 5 kilometer race that does not necessarily take place on the same course for each past performance), or may compete against predicted performances of the competitor's future self.

At step 350, the processing system presents visual data associated with the at least one video to a second competitor via a display device. For example, the visual data associated with the at least one video may comprise at least a portion of the at least one video, or the visual data may be generated from the at least one video. For instance, in one example, step 350 may include applying machine learning/artificial intelligence processes to the at least one video to generate a new video from a vantage different from that which original video was captured. In one example, step 350 may include extracting items/objects and separating from background (e.g., for AR content to be projected for second competitor). For instance, step 350 may comprise removing items/object from view in one or more frames (and may include re-inserting items or objects into later or earlier frames (e.g., in one example, a dog running onto a course may be tied to the location and not the time of the occurrence within the sequence from the start to the event as experienced by the first competitor)). In one example, the visual data associated with the at least one video may comprise an image of the first competitor (e.g., which may be presented when second competitor is behind and within viewing distance of competitor 1). In one example, the display device may comprise an augmented reality headset. In another example, the display screen may comprise a television, a monitor, or the like, which may be placed in a position viewable from a treadmill, rowing machine, stationary cycle, or the like.

At step 360, the processing system controls at least one setting of at least one device associated with the second competitor to simulate the at least one condition, where the at least one device is distinct from the display device. For example, the at least one device may comprise a rowing machine, a stationary cycle, a treadmill, or a pool comprising at least one water jet/pump, valve or mechanical guide. In one example, the at least one setting may comprise an additional resistance beyond a default resistance, where the additional resistance is proportional to a measure of the surface condition. For instance, in the case of a treadmill, a resistance may be added to the conveyor pad, in the case of a rowing machine, a resistance may be added to a flywheel, in the case of the stationary cycle, resistance may be added to the pedals or to one or more wheels, in the case of a pool, the speed of the jets may be used to control a flow of water/current, and so on. In one example, the at least one device may comprise a humidistat, a thermostat, a pressure control device (e.g., a room pressurizer which can be controlled to simulate competing at a particular altitude), a fan, a water sprinkler, a light or lighting system to shine at the second competitor from a particular angle and brightness, jets or valves to add waves or turbulence to a pool, if available, and so forth.

In an example where the at least one device comprises a treadmill, the at least one setting may comprise a setting for a surface firmness. Similarly, the processing system may also control the at least one setting to make a treadmill, rowing machine, or stationary bike wet to simulate competing in rain and/or having wet surface conditions. On the other hand, when the effect of surface conditions cannot be re-created (e.g., stationary bike vs. riding on wet roads) a correction/penalty factor may be imposed so as to account for an expected decline in performance due to the surface condition. A similar correction/penalty factor may be imposed where other conditions cannot be accurately re-created (such as a facility that is not equipped to adjust and simulate atmospheric pressure, for example). In addition, in one example, the controlling at least one setting of at least one device may further comprise adjusting the at least one setting in correspondence to a difference between the at least the first biometric condition of the first competitor and the at least the second biometric condition of the second competitor that may be determined at optional steps 330 and 340, such as adding resistance to level the competition between a parent and child, between an amateur and professional, and so forth based upon the difference(s) in biometric condition(s).

Following step 360, the method 300 proceeds to step 395. At step 395, the method 300 ends.

It should be noted that the method 300 may be expanded to include additional steps, or may be modified to replace steps with different steps, to combine steps, to omit steps, to perform steps in a different order, and so forth. For instance, in one example, the processing system may repeat one or more steps of the method 300, such as performing steps 310-320 or steps 310-330 on an ongoing basis for the duration for the event as experienced by the first competitor and steps 350-360 or steps 340-360 on an ongoing basis for the duration for the event as experienced by the second competitor. In one example, the processing system may repeat steps 350-360 or steps 340-360 for a third competitor, a fourth competitor, and so forth. For instance, multiple additional competitors may experience/participate in the event and compete virtually against the first competitor. In various other examples, the method 300 may further include or may be modified to comprise aspects of any of the above-described examples in connection with FIGS. 1 and 2, or as otherwise described in the present disclosure. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method 300 can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method 300 can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1 or described in connection with FIG. 2 or 3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for presenting a simulated environment of a competition route for a second competitor, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for presenting a simulated environment of a competition route for a second competitor (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for presenting a simulated environment of a competition route for a second competitor (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, at least one video of a first competitor along a competition route in a physical environment;
obtaining, by the processing system, data characterizing at least one condition along the competition route as experienced by the first competitor;
presenting, by the processing system, visual data associated with the at least one video to a second competitor via a display device; and
controlling, by the processing system, at least one setting of at least one device associated with the second competitor to simulate the at least one condition, wherein the at least one device is distinct from the display device.

2. The method of claim 1, wherein the data characterizing the at least one condition is obtained from at least one environmental sensor.

3. The method of claim 2, wherein the at least one environmental sensor comprises at least one of:
a light sensor;
a humidity sensor;
a temperature sensor;
a wind sensor; or
an atmospheric pressure sensor.

4. The method of claim 1, wherein the data characterizing the at least one condition is detected from the at least one video.

5. The method of claim 4, wherein the at least one condition comprises at least one of:
an occurrence of at least one movable obstacle;
a precipitation condition;
a light condition;
a surface type;
a wind condition; or
a surface condition.

6. The method of claim 1, wherein the at least one video is obtained from at least one of:
a camera of a wearable computing device of the first competitor; or
an uncrewed vehicle.

7. The method of claim 1, wherein the visual data associated with the at least one video comprises at least a portion of the at least one video, or wherein the visual data is generated from the at least one video.

8. The method of claim 1, wherein the visual data associated with the at least one video comprises an image of the first competitor.

9. The method of claim 1, wherein the data characterizing the at least one condition comprises data pertaining to a surface along the competition route, wherein the at least one condition comprises at least one of:
a surface type; or
a surface condition.

10. The method of claim 9, wherein the at least one setting comprises an additional resistance beyond a default resistance, wherein the additional resistance is proportional to a measure of the surface condition.

11. The method of claim 10, wherein the at least one device comprises:
a rowing machine;
a stationary cycle;
a treadmill; or
a pool comprising at least one water jet/pump.

12. The method of claim 9, wherein the data pertaining to the surface along the competition route is obtained from at least one sensor of an object in contact with the surface.

13. The method of claim 1, wherein the at least one device comprises:
a humidistat;
a thermostat;
a pressure control device;
a fan; or
a water sprinkler.

14. The method of claim 1, wherein the at least one device comprises a treadmill, wherein the at least one setting comprises a setting for a surface firmness.

15. The method of claim 1, further comprising:
determining at least a first biometric condition of the first competitor; and
determining at least a second biometric condition of the second competitor, wherein the second biometric condition is of a same type of biometric condition as the first biometric condition.

16. The method of claim 15, wherein the controlling at least one setting of at least one device further comprises adjusting the at least one setting in correspondence to a difference between the at least the first biometric condition of the first competitor and the at least the second biometric condition of the second competitor.

17. The method of claim 15, wherein the same type of biometric condition comprises:
a leg length;
a femur length;
a stride length;
an arm reach;
a height; or
an age.

18. The method of claim 1, wherein an identity of the second competitor is the same as the first competitor.

19. A non-transitory computer-readable medium storing instructions which, when executed by a processing system including at least one processor, cause the processing system to perform operations, the operations comprising:
obtaining at least one video of a first competitor along a competition route in a physical environment;
obtaining data characterizing at least one condition along the competition route as experienced by the first competitor;
presenting visual data associated with the at least one video to a second competitor via a display device; and
controlling at least one setting of at least one device associated with the second competitor to simulate the at least one condition, wherein the at least one device is distinct from the display device.

20. An apparatus comprising:
a processing system including at least one processor; and
a computer-readable medium storing instructions which, when executed by the processing system, cause the processing system to perform operations, the operations comprising:
obtaining at least one video of a first competitor along a competition route in a physical environment;
obtaining data characterizing at least one condition along the competition route as experienced by the first competitor;
presenting visual data associated with the at least one video to a second competitor via a display device; and
controlling at least one setting of at least one device associated with the second competitor to simulate the at least one condition, wherein the at least one device is distinct from the display device.
